(19) United States
(12) Patent Application Publication
(10) Pub. No.: US 2010/0327844 A1
(43) Pub. Date: Dec. 30, 2010

(54) CURRENT MIRROR, DEVICES INCLUDING SAME, AND METHODS OF OPERATION THEREOF

(75) Inventor: Mahim Ranjan, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/821,049

(22) Filed: Jun. 22, 2010

Related U.S. Application Data
(60) Provisional application No. 61/219,748, filed on Jun. 23, 2009.

(51) Int. Cl. G05F 3/16

(52) U.S. Cl. 323/315

(57) ABSTRACT

Exemplary embodiments are directed to a current mirror and method of operation thereof. A method may include biasing a first transistor with a voltage at a gate of a second transistor to cause the first transistor to conduct, wherein the first transistor has a source operably coupled to a drain of a third transistor and a drain operably coupled to a gate of the third transistor. The method may also include providing an input current at the drain of the third transistor. Moreover, the method may include decreasing or increasing a voltage at the gate of the first transistor when a voltage at the gate of the second transistor and the drain of the first transistor respectively decreases or increases. Furthermore, the method may include generating an output current in a drain of a fourth transistor having a gate operably coupled to the gate of the third transistor.

### CLAIM OF PRIORITY UNDER 35 U.S.C. §119

This application claims priority under 35 U.S.C. §119(e) to:

U.S. Provisional Patent Application 61/219,748 entitled “LOW VOLTAGE CURRENT MIRROR WITH IMPROVED LINEARITY OVER PROCESS CORNERS” filed on Jun. 23, 2009, the disclosure of which is hereby incorporated by reference in its entirety.

### BACKGROUND

1. Field

The present invention relates generally to current mirrors, and more specifically to a current mirror having enhanced linearity across process corners, temperature changes, or both.

2. Background

Amplifiers are commonly used to amplify input signals to obtain output signals having the desired signal level. Various types of amplifiers are available and include voltage amplifiers, current amplifiers, etc. A voltage amplifier receives and amplifies an input voltage signal and provides an output voltage signal. A current amplifier receives and amplifies an input current signal and provides an output current signal. Voltage and current amplifiers typically have different designs and are used in different applications.

An amplifier may be designed to implement a particular transfer function, which may be dependent on an application for which the amplifier is used. Various circuit elements (e.g., transistors, resistors, capacitors, etc.) may be used to implement the transfer function. It is desirable to design the amplifier to obtain the transfer function while minimizing cost, size, power, etc.

FIG. 1 is a circuit diagram of a conventional low voltage current mirror 100 including a current source 106, a plurality of transistors MP1, MP2, MP3, GM1, GM2, MN1, and MN2, and an output current Iₒᵤₜₚᵤₜ. As will be understood by a person having ordinary skill in the art, current mirror 100 may comprise a low-voltage current mirror. As illustrated in FIG. 1, transistors MP1, MP2, and MP3 are connected in parallel and have their gates connected together and their sources connected to a bias voltage VDD. Transistor MP1 is connected in a diode configuration, which means that a gate and a drain of transistor MP1 are connected together. A bias current source 102, which is coupled between a drain of transistor MP1 and a ground voltage 104, provides a bias current Iᵢₙₚᵤₜ. The drain currents of transistors MP2 and MP1, respectively illustrated as current I₂ and current I₃, are determined by, and mirror, the drain current of transistor MP1 (i.e., bias current Iᵢₙₚᵤₜ).

As will be understood by a person having ordinary skill in the art, when a process corner of current mirror 100 changes from “typical” to “fast,” a voltage Vg2, which is at a gate of transistor GM2 and a drain a transistor GM1, may reduce. Accordingly, a voltage at the drain of transistor GM1 may also reduce. Furthermore, because a gate voltage of transistor GM1 is fixed (i.e., fixed at a voltage Vg1), a drain-to-source voltage of transistor GM1 may reduce at a fast process corner, which may cause transistor GM1 to enter a triode region and degrade the linearity of current mirror 100. As a result, degradation of the adjacent channel leakage ratio (ACLR), as will be understood by a person having ordinary skill in the art, may be increased. For example, a drain-to-source voltage of transistor GM1 may reduce from 291 mV at a typical corner to 117 mV at a fast MOS corner, a drop of 174 mV. Moreover, in this example, the ACLR may degrade by approximately 4.19 dB.

A need exists for a current mirror exhibiting enhanced linearity across process corners and temperature changes.

### BRIEF DESCRIPTION OF THE DRAWINGS

FIG. 1 is a circuit diagram of a conventional current mirror.

FIG. 2 is a circuit diagram of a current mirror, according to an exemplary embodiment of the present invention.

FIG. 3 is a circuit diagram of a low-pass filter including a current mirror, according to an exemplary embodiment of the present invention.

FIG. 4 is a flowchart illustrating a method, in accordance with an exemplary embodiment of the present invention.

FIG. 5 is a flowchart illustrating another method, in accordance with an exemplary embodiment of the present invention.

FIG. 6 is a block diagram of an electronic device including at least one current mirror, in accordance with an exemplary embodiment of the present invention.

FIG. 7 is a more detailed block diagram of an electronic device including at least one current mirror, in accordance with an exemplary embodiment of the present invention.

FIG. 8 is another block diagram of an electronic device including a current mirror, according to an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Various exemplary embodiments as described herein are related to methods and devices for reducing degradation of adjacent channel leakage ratio of a current mirror in comparison to various conventional current mirrors. As will be understood by a person having ordinary skill in the art, a current mirror is a circuit that may include multiple transistors connected in parallel, with their gates connected together and their sources connected to the same voltage, so that a current flowing through one transistor mirrors the current flowing through another transistor.

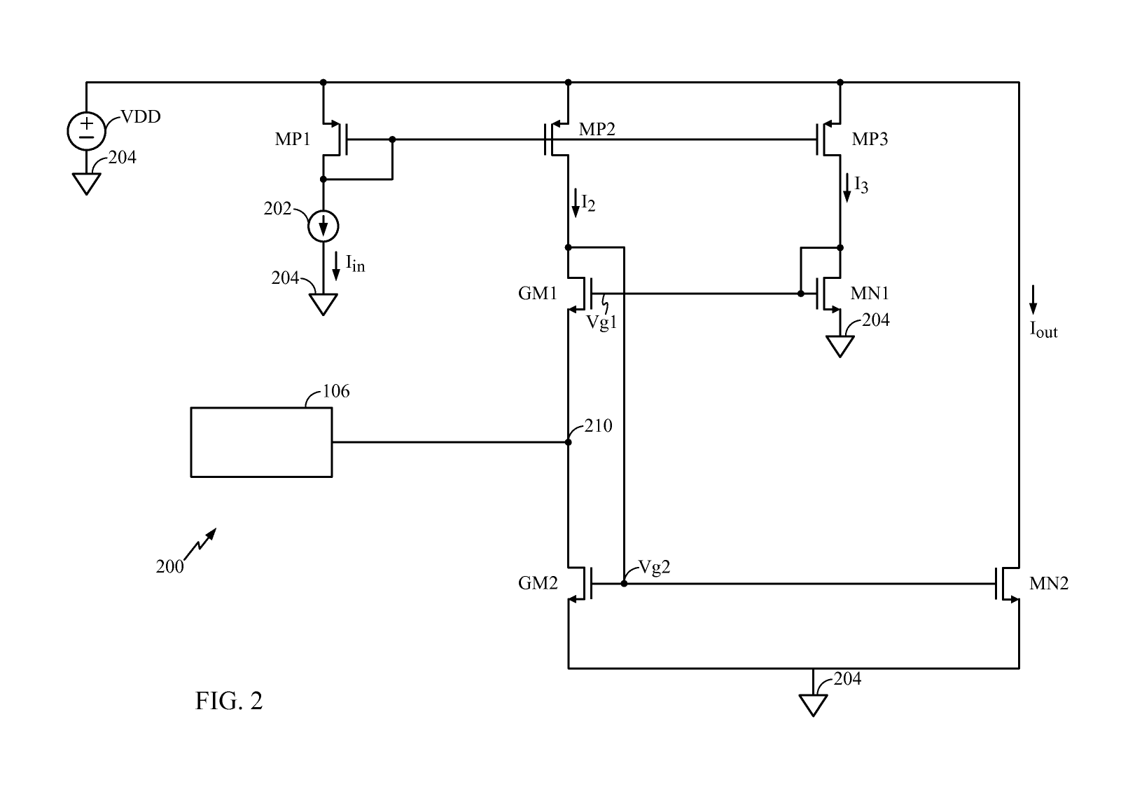

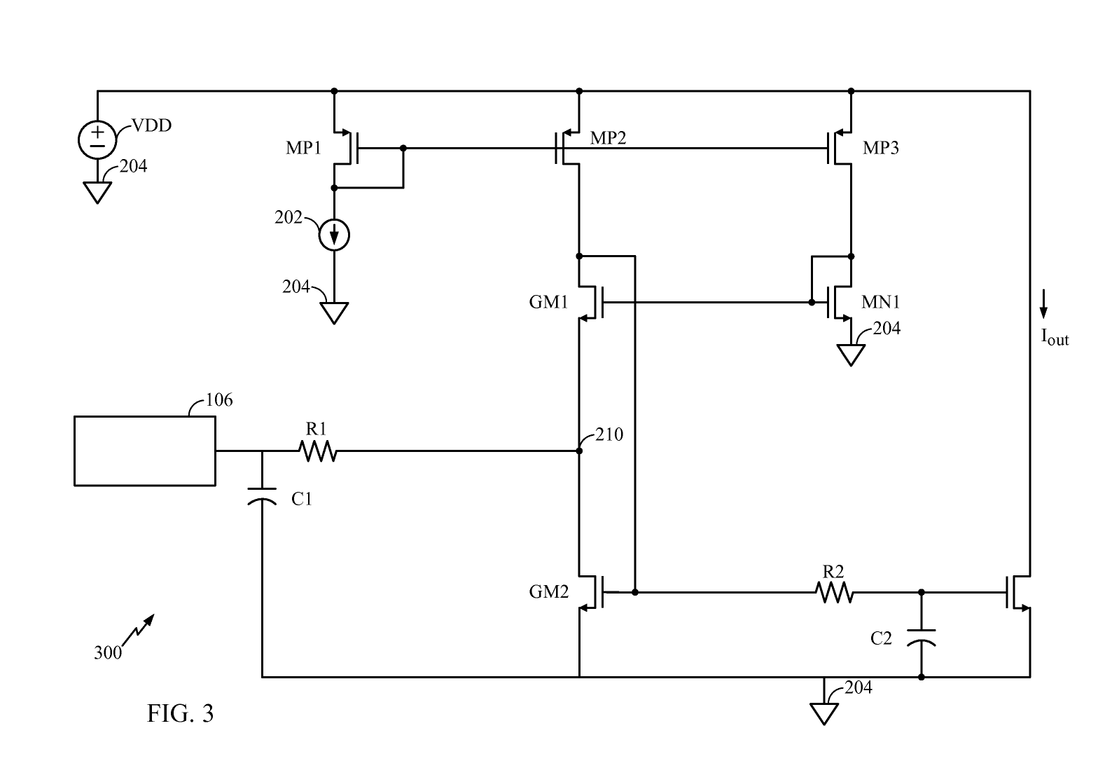

FIG. 2 is a circuit diagram of a current mirror 200 including input current source 106, transistors MP1, MP2, MP3, GM1, GM2, MN1, and MN2, and an output current Iout. It is noted that in FIGS. 2 and 3, current mirror 200 is implemented in complementary metal oxide semiconductor (CMOS) with both N-FETs and P-FETs. For example only, transistors MP1, MP2, and MP3 may each comprise positive-channel metal-oxide semiconductor (PMOS) transistors and transistors GM1, GM2, MN1, and MN2 may each comprise negative-channel metal-oxide semiconductor (NMOS) transistors. Current mirror 200 may also be referred to herein as a “low-voltage current mirror.”

As illustrated in FIG. 2, current source 106 is operably coupled to a node 210, which is coupled to each of a drain of transistor GM2 and a source of transistor GM1. Moreover, transistors MP1, MP2, and MP3 are connected in parallel and have their gates connected together and their sources connected to bias voltage VDD. Bias voltage VDD is further coupled to a ground voltage 204. Transistor MP1 is connected in a diode configuration (i.e., a gate and a drain of transistor MP1 are connected together). A bias current source 202, which is coupled between the drain of transistor MP1 and ground voltage 204, provides a bias current Iin.

With further reference to FIG. 2, a drain of transistor MP2 is operably coupled to a drain of transistor GM1, and a drain of transistor MP3 is operably coupled to a drain of transistor MN1. A source of transistor MN1 is operably coupled to ground voltage 204 and a gate of transistor MN1 is operably coupled to a gate of transistor GM1. Moreover, the drain of transistor GM1 is operably coupled to a gate of transistor GM2, which is further coupled to a gate of transistor MN2. A source of transistor GM2 and a source of transistor MN2 are each operably coupled to ground voltage 204. Additionally, the gate of transistor MN1 is operably coupled to the drain of transistor MN1. It is noted that, according to an exemplary embodiment, transistor MN1 and transistor GM2 may comprise the same type of device (e.g., both transistor MN1 and transistor GM2 may comprise an NMOS device). The drain currents of transistors MP2 and MP3, respectively illustrated as current I2 and current I3, are determined by, and mirror, the drain current of transistor MP1 (i.e., bias current Iin). Moreover, an output current Iout may be generated in a drain of transistor MN2.

A contemplated operation of current mirror 100 will now be described. In response to bias current Iin, currents I2 and I3 are generated in the drains of transistors MP2 and MP3, respectively. Furthermore, as will be appreciated by a person having ordinary skill in the art, each of a current through transistor GM2 and a current through transistor MN1 (i.e., current I3) may be each be constant. Furthermore, as the process corner transitions from “typical” to “fast,” a transconductance of transistor GM2 and a transconductance of transistor MN1 may both change. Therefore, a voltage VG2 at the gate of transistor GM2 and a voltage at the drain of transistor GM1 may both reduce.

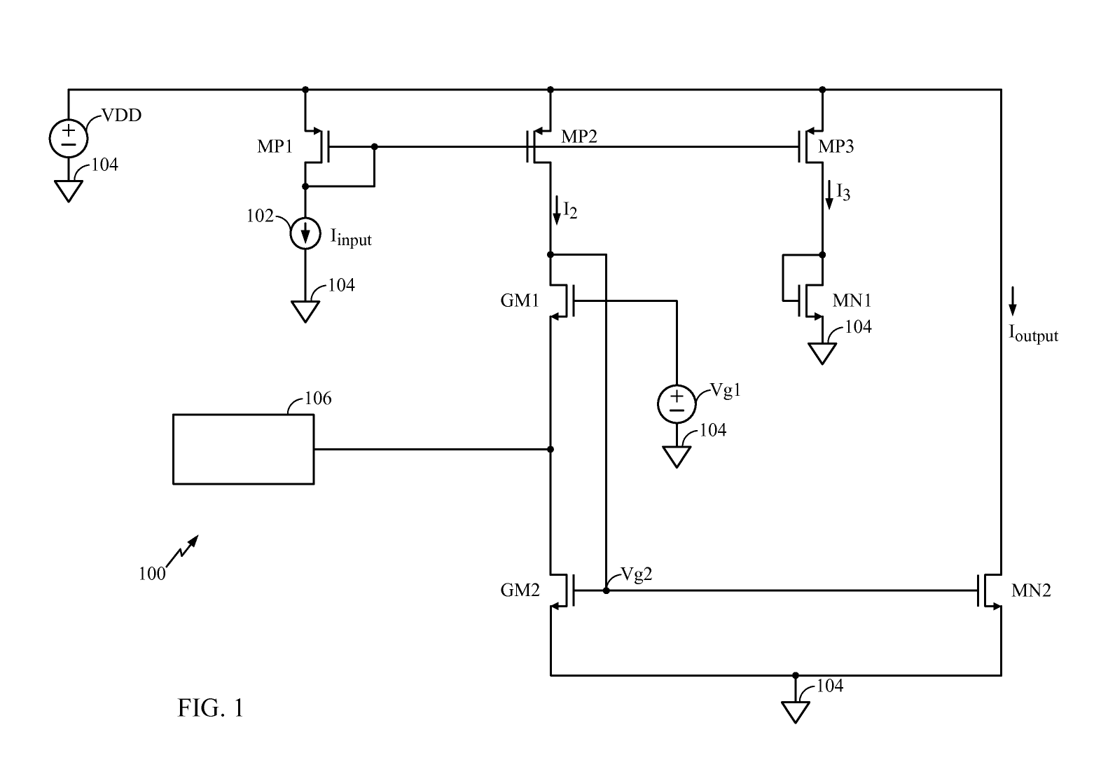

As will be appreciated by a person having ordinary skill in the art, a voltage at the gate of transistor NM1 may track the voltage at the gate of transistor GM2. Stated another way, a voltage at the gate of transistor MN1 may increase or decrease in a manner similar to that of a voltage at the gate of transistor GM2. For example, as the voltage at the gate of transistor GM2 increases, the voltage at the gate of transistor MN1 may also increase. Similarly, as the voltage at the gate of transistor GM2 decreases, the voltage at the gate of transistor MN1 may also decrease. As a result, as a voltage at the drain of transistor GM1 reduces, the voltage at the gate of transistor GM1 may also reduce. Accordingly, a drain-to-source voltage of transistor GM1 may reduce less than a case wherein a voltage at the gate of transistor GM1 is fixed. For example only, during a contemplated operation of current mirror 200, a drain-to-source voltage of transistor GM1 may reduce by 81 mV at a “fast” corner, compared to a reduction of 174 mV in an example case wherein a voltage at the gate of transistor GM1 is fixed (e.g., current mirror 100 illustrated in FIG. 1). Hence, the likelihood that transistor GM1 remains in a saturation region is increased and the linearity of current mirror 200 may be maintained.

As will be appreciated by a person having ordinary skill in the art, ACLR may be defined as a ratio of the inbound signal power to the output distortion power. Table 1 provides examples of adjacent channel leakage ratios for process corners of current mirror 100 illustrated in FIG. 1 and current mirror 200 illustrated in FIG. 2. As illustrated in Table 1, upon transitioning from a “typical” to a “fast” process corner, the ACLR associated with current mirror 100 degrades by approximately 4.19 dB (i.e., 54.19-50.0). In comparison, as also illustrated in Table 1, upon transitioning from a “typical” to a “fast” process corner of current mirror 200, the degradation in the associated ACLR is only 1.44 dB (i.e., 54.24-52.8). It is noted that the ACLR measurements associated with Table 1 were measured with a WCDMA signal, as defined by the UMTS standard.

TABLE 1

| | ACLR of conventional | ACLR of current |
|---|---|---|
| Process | current mirror | mirror illustrated |
| Corner | illustrated in FIG. 1 | in FIG. 2 |
| Typical | 54.19 | 54.24 |
| Fast | 50.0 | 52.8 |
| Slow | 55.0 | 55.0 |

FIG. 3 is a circuit diagram of a low-pass filter 300 including current mirror 200.

As will be appreciated by a person having ordinary skill in the art, in addition to current mirror 200, low-pass filter 300 includes a first RC filter including a resistor R1 and a capacitor C2 and a second RC filter including a resistor R2 and a capacitor C2.

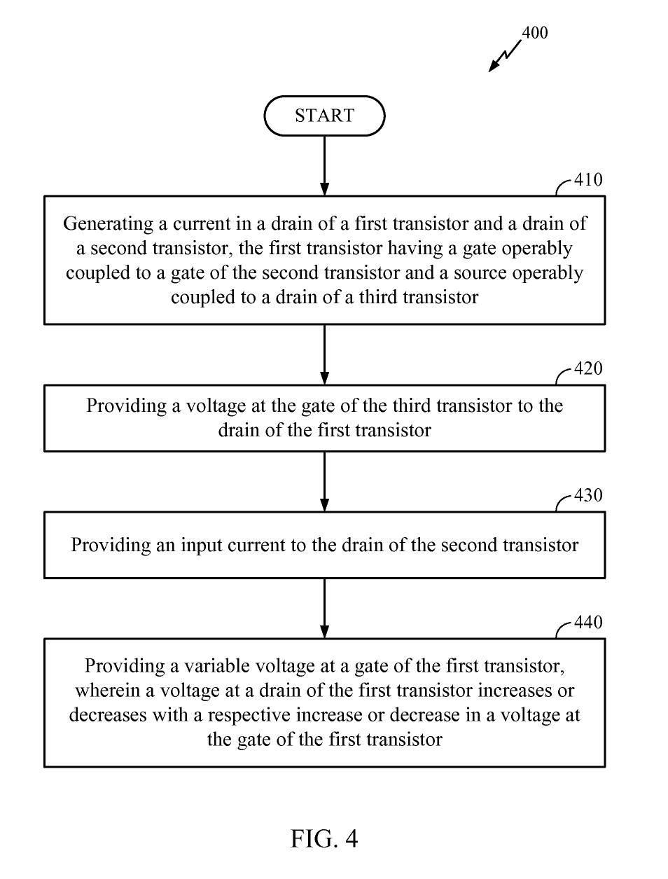

FIG. 4 is a flowchart illustrating a method 400, in accordance with one or more exemplary embodiments. Method 400 may include generating a current in a drain of a first transistor and a second transistor, the first transistor having a gate operably coupled to a gate of the second transistor and a source operably coupled to a drain of a third transistor (depicted by numeral 410). Method 400 may further include providing a voltage at the gate of the third transistor to the drain of the first transistor (depicted by numeral 420). Moreover, method 400 may include providing an input current to the drain of the second transistor (depicted by numeral 430). Method 400 may also include providing a variable voltage at a gate of the first transistor, wherein a voltage at a drain of the first transistor increases or decreases with a respective increase or decrease in a voltage at the gate of the first transistor (depicted by numeral 440).

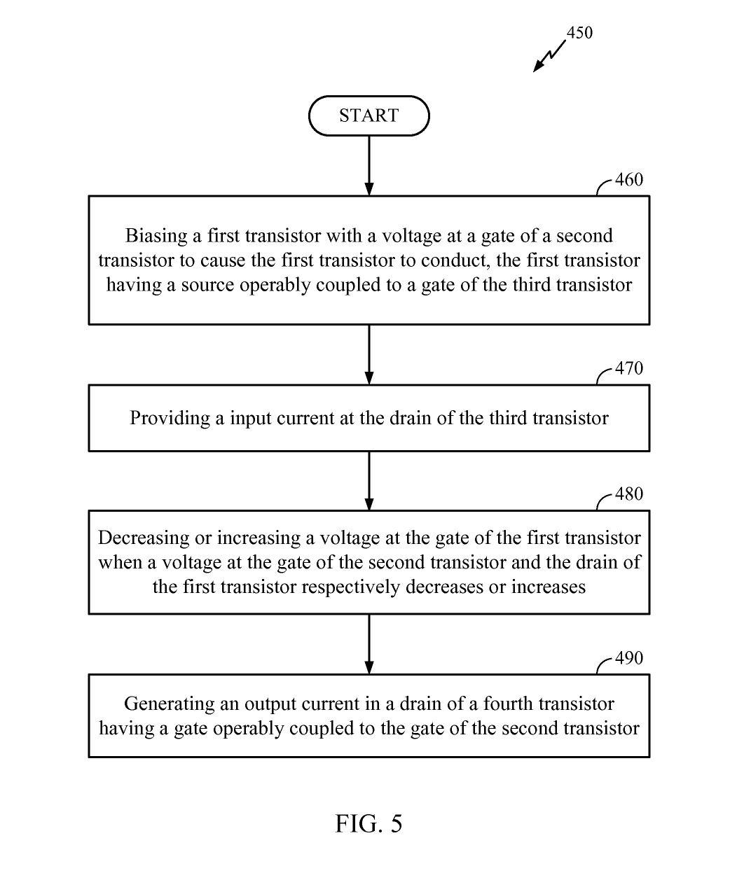

FIG. 5 is a flowchart illustrating another method 450, in accordance with one or more exemplary embodiments. Method 450 may include biasing a first transistor with a voltage at a gate of a second transistor to cause the first transistor to conduct, the first transistor having a source operably coupled to a drain of a third transistor and a drain operably coupled to a gate of the third transistor (depicted by numeral 460). Method 450 may further include providing an input current at the drain of the third transistor (depicted by numeral 470). Moreover, method 450 may include decreasing or increasing a voltage at the gate of the first transistor when a voltage at the gate of the second transistor and the drain of the first transistor respectively decreases or increases (depicted by numeral 480). Method 450 may also include generating an output current in a drain of a fourth transistor having a gate operably coupled to the gate of the second transistor (depicted by numeral 490).

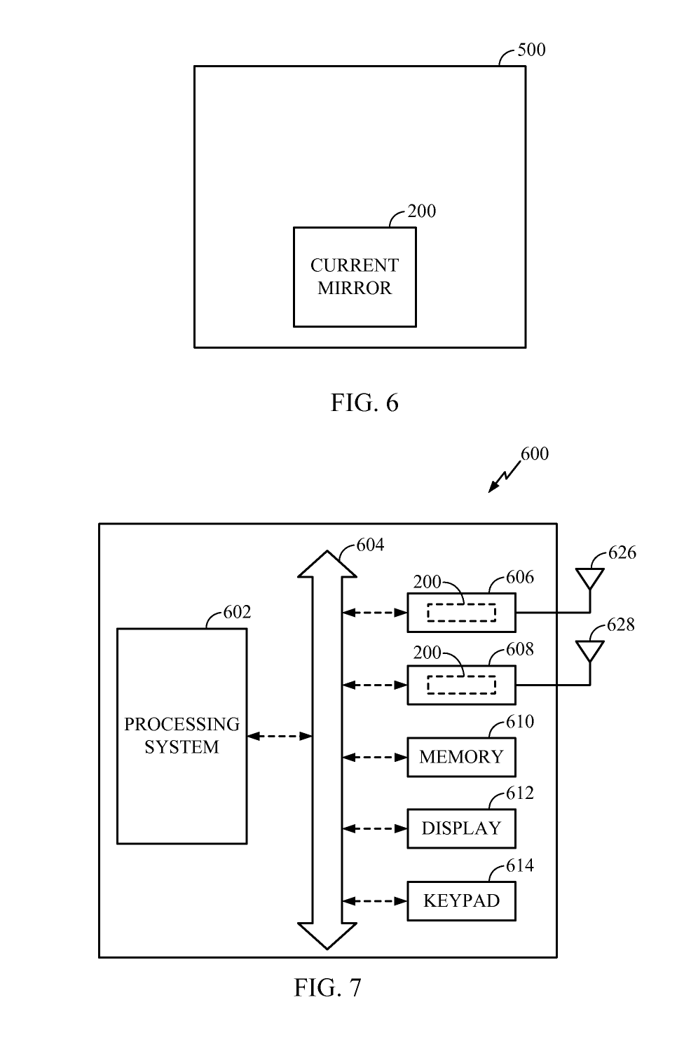

FIG. 6 is a block diagram of an electronic device 500 including at least one current mirror 200 in accordance with an exemplary embodiment described herein. Electronic device 500 may include any known and suitable electronic device such as, for example only, a mobile telephone, a media player, a camera, and the like. As a more specific example, FIG. 7 is a block diagram illustrating an example of a hardware configuration of an electronic device according to one aspect of the disclosure. An electronic device 600 may include a processing system 602, which is capable of communication with a receiver 606 and a transmitter 608 through a bus 604 or other structures or devices. As illustrated, receiver 606, transmitter 608, or both, may include current mirror 200, according to the exemplary embodiments described herein. Receiver 606 may receive signals from an antenna 626, and the transmitter 608 may transmit signals using an antenna 628. It should be understood that communication means other than buses can be utilized with the disclosed configurations. Processing system 602 can generate audio, video, multimedia, and/or other types of data to be provided to the transmitter 608 for communication. In addition, audio, video, multimedia, and/or other types of data can be received at the receiver 606, and processed by processing system 602

One or more software applications, which may be stored in a memory 610 or processing system 602, may be used by processing system 602 to control and manage access to the various networks, as well as provide other communication and processing functions. Software programs may also provide an interface to processing system 602 for various user interface devices, such as a display 612 and a keypad 614. Processing system 102 may be implemented using software, hardware, or a combination of both.

While FIG. 7 shows two separate antennas 626 and 628, an electronic device may employ one common antenna for both receiver 606 and transmitter 608, or may employ multiple antennas (e.g., each or one of receiver 606 and transmitter 608 may include more than one antenna). In another configuration, antennas 626 and 628 may be replaced by wire connections to other systems (e.g., optical fibers, cables).

An electronic device may also include other components that are not shown in FIG. 7 (e.g., peripheral devices) or may include fewer components than what is shown in FIG. 7. Receiver 606 and transmitter 608 may be combined into a transceiver in another configuration. Some of the functions of processing system 602 may be performed by one or more of the other blocks shown in FIG. 7, such as receiver 606 and transmitter 608, and some of the functions of the receiver 606 and/or the transmitter 608 may be performed by one or more of the other blocks, such as processing system 602. Electronic device 600 is merely an example, and the subject technology may be practiced in other types of devices. Furthermore, an electronic device such as electronic device 600 can be utilized in a wireless or wired communications system or other types of systems or devices.

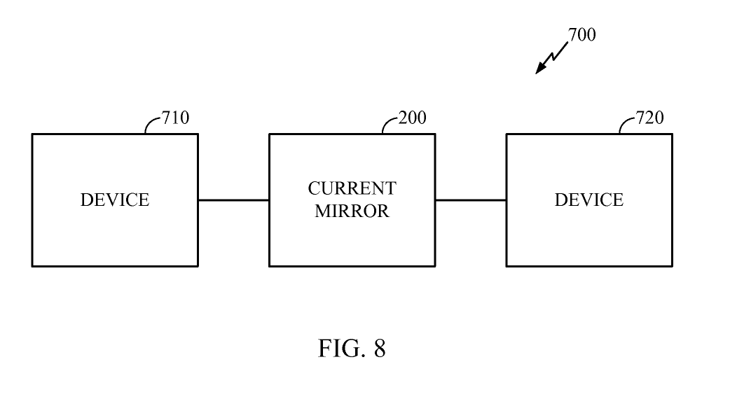

FIG. 8 is another block diagram of an electronic device 700 including current mirror 200 operably coupled between a first device 710 and a second device 720. Current mirror 200 may be configured to receive an input current from first device 710 and convey an output current to second device 720. As a non-limiting example, first device may comprise a digital-to-analog converter. Furthermore, second device 720 may comprise, for example only, a mixer.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The current amplifier described herein may be implemented in an analog IC, an RFIC, an ASIC, a digital signal processor (DSP), a digital signal processing device (DSPD), a programmable logic device (PLD), a field programmable gate array (FPGA), a processor, a controller, a micro-controller, a microprocessor, and other electronic units. The current amplifier may be implemented in various IC process technologies such as N-MOS, P-MOS, CMOS, BJT, GaAs, etc. The dual-path current amplifier may also be implemented with discrete components.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A circuit, comprising:
a first transistor having a drain operably coupled to a drain of one transistor of a plurality of transistors operably coupled in parallel;
a second transistor having a drain operably coupled to a source of the first transistor, wherein the drain of the first transistor is operably coupled to a gate of the second transistor; and
a third transistor having a drain operably coupled to each of a gate of the third transistor and a drain of another transistor of the plurality of transistors, wherein a gate of the third transistor is operably coupled to a gate of the first transistor.

2. The circuit of claim 1, further comprising a current source operably coupled to each of the source of the first transistor and the drain of the second transistor.

3. The circuit of claim 1, wherein each of the source of the second transistor and the source of the third transistor is operably coupled to a ground voltage.

4. The circuit of claim 1, wherein each transistor of the plurality of transistors comprises a PMOS transistor.

5. The circuit of claim 1, wherein each of the first transistor, the second transistor, and the third transistor comprises an NMOS transistor.

6. The circuit of claim 1, further comprising a fourth transistor having a gate operably coupled to the gate of the second transistor and a drain operably coupled to the bias voltage.

7. The circuit of claim 6, wherein a source of the fourth transistor is operably coupled to a ground voltage.

8. The circuit of claim 6, wherein the drain of the fourth transistor is configured to receive an output signal.

9. The circuit of claim 1, wherein a current in the drain of the first transistor and a current in the drain of the third transistor are substantially equal.

10. A method, comprising:
generating a current in a drain of a first transistor and a drain of a second transistor, the first transistor having a gate operably coupled to a gate of the second transistor and a source operably coupled to a drain of a third transistor;
providing a voltage at the gate of the third transistor to the drain of the first transistor;
providing an input current to the drain of the third transistor; and
providing a variable voltage at the gate of the first transistor, wherein a voltage at a drain of the first transistor increases or decreases with a respective increase or decrease in a voltage at the gate of the first transistor.

11. The method of claim 10, further comprising generating an output current in a drain of a fourth transistor having a gate operably coupled to a gate of the second transistor.

12. The method of claim 10, wherein generating a current in the drain of the first transistor comprises generating a current in the drain of the first transistor operably coupled to the gate of the third transistor.

13. The method of claim 10, wherein generating a current in the drain of the second transistor comprises generating a current in the drain of the second transistor operably coupled to the gate of the second transistor.

14. A method of operating a current mirror, comprising:
biasing a first transistor with a voltage at a gate of a second transistor to cause the first transistor to conduct, the first transistor having a source operably coupled to a drain of a third transistor and a drain operably coupled to a gate of the third transistor;
providing a input current at the drain of the third transistor;
decreasing or increasing a voltage at the gate of the first transistor when a voltage at the gate of the second transistor and the drain of the first transistor respectively decreases or increases; and
generating an output current in a drain of a fourth transistor having a gate operably coupled to the gate of the third transistor.

15. The method of claim 14, further comprising generating a current in a drain of the first transistor and a drain of the second transistor.

16. The method of claim 14, wherein providing an input current comprises conveying the input current from a digital-to-analog converter to the drain of the third transistor.

17. A device, comprising:
means for biasing a first transistor with a voltage at a gate of a second transistor to cause the first transistor to conduct, the first transistor having a source operably coupled to a drain of a third transistor and a drain operably coupled to a gate of the third transistor; and
means for providing a input current at the drain of the third transistor;
means for decreasing or increasing a voltage at the gate of the first transistor when a voltage at the gate of the second transistor and the drain of the first transistor respectively decreases or increases; and
means for generating an output current in a drain of a fourth transistor having a gate operably coupled to the gate of the third transistor.

18. An electronic device including at least one current mirror, the at least one current mirror comprising
a first transistor having a source operably coupled to a drain of a second transistor, a gate of the second transistor operably coupled to a drain of the first transistor;
an input current source operably coupled to each of the source of the first transistor and the drain of the second transistor;
a third transistor having a gate operably coupled to a gate of the first transistor; and
a fourth transistor having a gate operably coupled to a gate of the second transistor, wherein a drain of the fourth transistor receives an output current.

19. The device of claim 18, further comprising a plurality of transistors operably coupled in parallel, wherein a source of each transistor of the plurality of transistors is operably coupled to a bias voltage, the drain of the first transistor operably coupled to a drain of one transistor of the plurality of transistors and a drain of the third transistor operably coupled to a drain of another transistor of the plurality of transistors.

20. The device of claim 18, further a first RC filter operably coupled to the input current source and a second RC filter operably coupled to the fourth transistor.

21. The device of claim 18, wherein the third transistor is connected in a diode configuration.

22. The device of claim 18, wherein each of a source of the fourth transistor, a source of the second transistor, and a source of the third transistor are operably coupled to a ground voltage.

23. The device of claim 18, wherein the drain of the fourth transistor is operably coupled to a bias voltage.
